(19) United States
(12) Patent Application Publication
(10) Pub. No.: US 2022/0347043 A1
(43) Pub. Date: Nov. 3, 2022

(54) Infant Burping Assembly

(71) Applicant: Asia Simms, Jersey City, NJ (US)

(72) Inventor: Asia Simms, Jersey City, NJ (US)

(21) Appl. No.: 17/243,886

(22) Filed: Apr. 29, 2021

(51) Int. Cl. A61H 11/00; A61H 9/00; A61H 23/02

(52) U.S. Cl. CPC A61H 11/00; A61H 9/0078; A61H 23/02; A61H 2201/0207; A61H 2011/005; A61H 2201/5097; A61H 2201/5025; A61H 2201/165; A61H 2205/081; A61H 2201/1207

(57) ABSTRACT

An infant burping assembly includes a belt that is longitudinally elongated for wearing around an infant's torso. An inflation unit is integrated into the belt and the inflation unit is repeatedly inflated and deflated when the inflation unit is turned on. In this way the inflation unit repeatedly engages the infant's back for burping the infant. A heating element is integrated into the belt to warm the infant when the heating element is turned on. A vibration unit is integrated into the belt to massage the infant when the vibration unit is turned on. A remote control is provided and the remote control is in remote communication with each of the inflation unit, the heating element and the vibration unit for turning each of the inflation unit, the heating element and the vibration unit on and off.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to burping devices and more particularly pertains to a new burping device for automatically burping an infant.

### (2) Description of Related Art Including Information Disclosed Under 37 CFR 1.97 and 1.98

The prior art relates to burping devices including a vibrating baby blanket that simulates the touch of a parent. The prior art also discloses a heated lining for a coat. The prior art discloses a warming device that transmits heat to an object via a radio frequency signal. The prior art discloses a garment that is wearable on an infant which includes a vibration unit for massaging and soothing the infant. The prior art discloses a massaging blanket that has an eccentric massage unit integrated therein for massaging an infant around which the massaging blanket is wrapped. The prior art also discloses a method of applying motion stimulations on a body by using piezo-electric actuators.

### BRIEF SUMMARY OF THE INVENTION

An embodiment of the disclosure meets the needs presented above by generally comprising a belt that is longitudinally elongated for wearing around an infant's torso. An inflation unit is integrated into the belt and the inflation unit is repeatedly inflated and deflated when the inflation unit is turned on. In this way the inflation unit repeatedly engages the infant's back for burping the infant. A heating element is integrated into the belt to warm the infant when the heating element is turned on. A vibration unit is integrated into the belt to massage the infant when the vibration unit is turned on. A remote control is provided and the remote control is in remote communication with each of the inflation unit, the heating element and the vibration unit for turning each of the inflation unit, the heating element and the vibration unit on and off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an infant burping assembly according to an embodiment of the disclosure.

FIG. 2 is a perspective in-use view of an embodiment of the disclosure.

FIG. 3 is a top view of an embodiment of the disclosure.

FIG. 4 is a front view of an embodiment of the disclosure.

FIG. 5 is a top phantom view of an embodiment of the disclosure.

FIG. 6 is a bottom phantom view of an embodiment of the disclosure.

FIG. 7 is a schematic view of an embodiment of the disclosure.

### DETAILED DESCRIPTION OF THE INVENTION

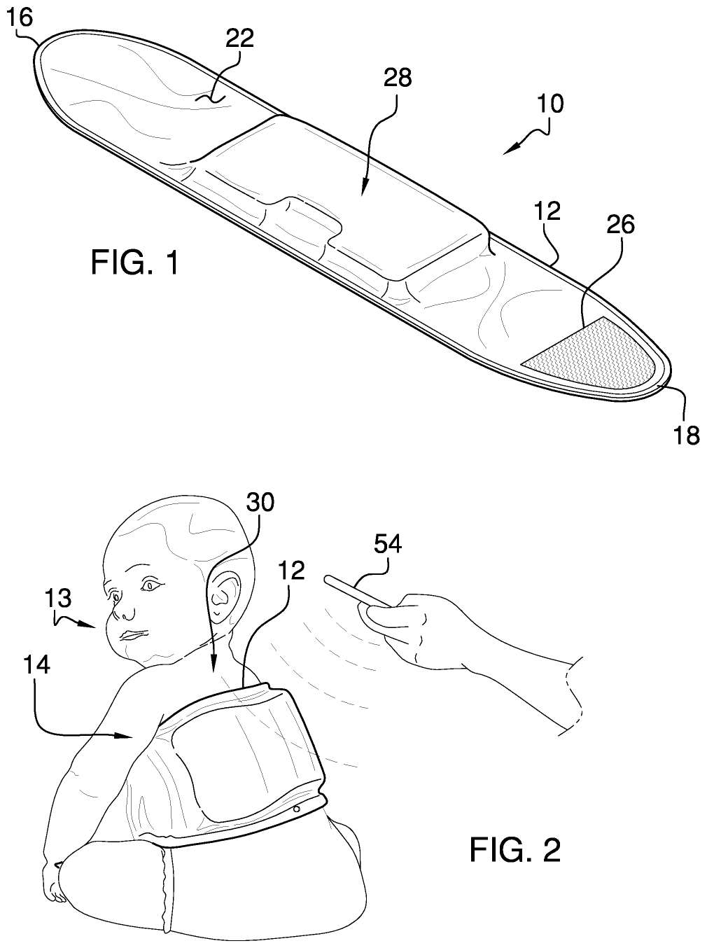

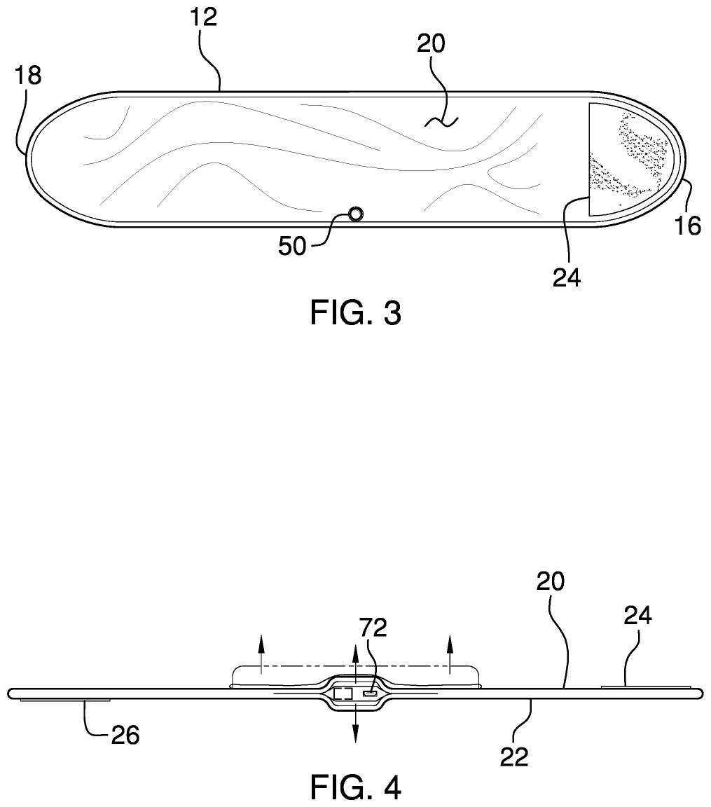

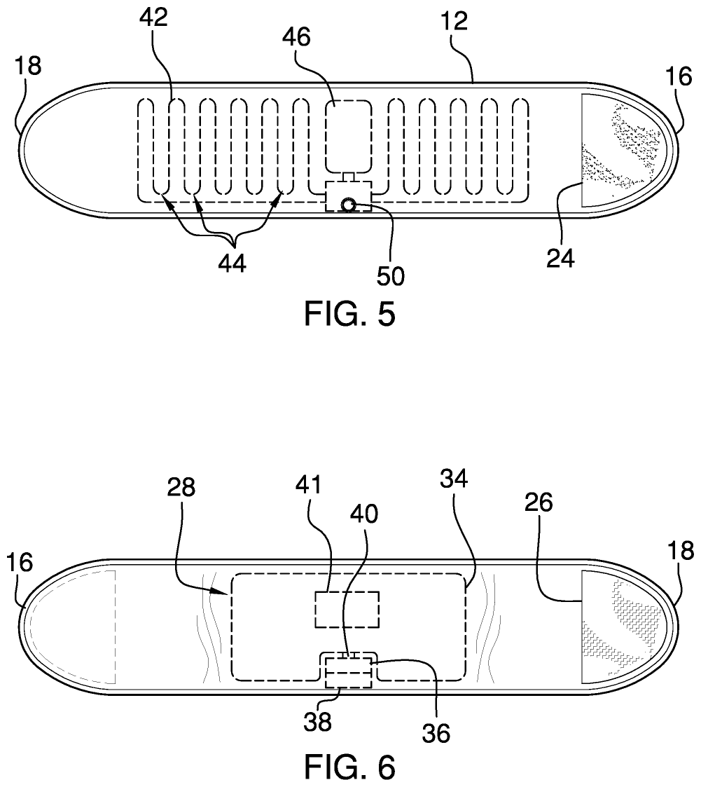

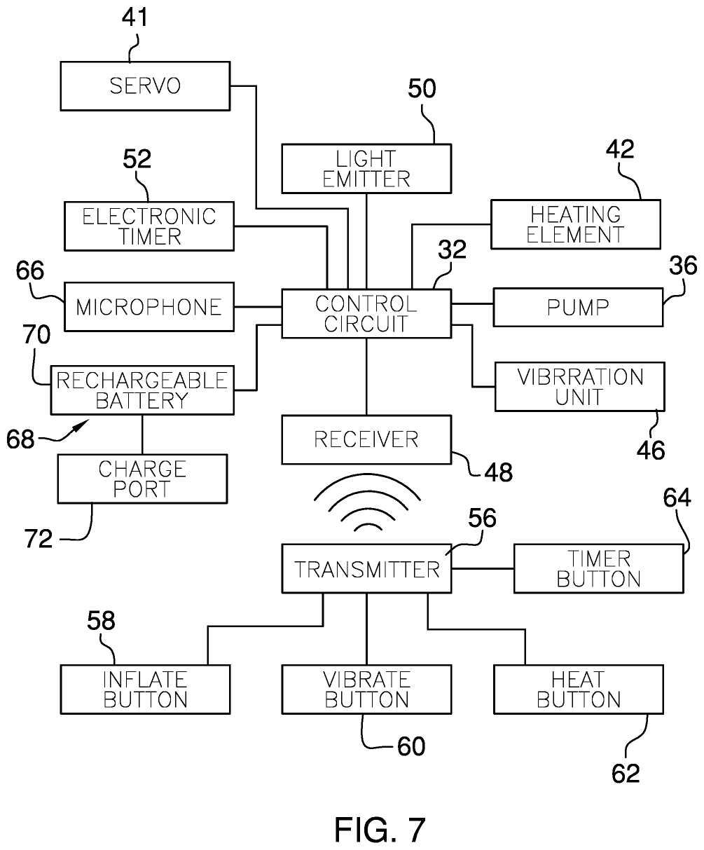

With reference now to the drawings, and in particular to FIGS. 1 through 7 thereof, a new burping device embodying the principles and concepts of an embodiment of the disclosure and generally designated by the reference numeral 10 will be described.

As best illustrated in FIGS. 1 through 7, the infant burping assembly 10 generally comprises a belt 12 that is longitudinally elongated for wearing around an infant's 13 torso 14. The belt 12 has a first end 16, a second end 18, a top surface 20 and a bottom surface 22, and the bottom surface 22 is positioned against the infant 13 when the belt 12 is worn. Moreover, the belt 12 is elongated between the first end 16 and the second end 18. The belt 12 is comprised of deformable material, such as an organic textile or synthetic fiber, thereby facilitating the belt 12 to comfortably conform to the infant's 13 torso 14.

A first mating member 24 is coupled to the belt 12, the first mating member 24 is positioned on the top surface 20 and the first mating member 24 is positioned adjacent to the first end 16. A second mating member 26 is coupled to the belt 12 and the second mating member 26 is releasably matable to the first mating member 24 for forming the belt 12 into a closed loop. In this way the belt 12 is retained around the infant's 13 torso 14. The second mating member 26 is positioned on the bottom surface 22 and the second mating member 26 is aligned with the second end 18. Each of the first mating member 24 and the second mating member 26 may comprise complementary portions of a hook and loop fastener or other type of releasable fastener.

An inflation unit 28 is integrated into the belt 12 and the inflation unit 28 is in communication with the infant's 13 back 30 when the belt 12 is worn. The inflation unit 28 is repeatedly inflated and deflated when the inflation unit 28 is turned on. In this way the inflation unit 28 repeatedly engages the infant's 13 back 30 for burping the infant 13. The inflation unit 28 comprises a control circuit 32 that is integrated into the belt 12. The control circuit 32 receives a pump input, a heat input and a vibrate input.

The inflation unit 28 includes a bladder 34 that is positioned between the top surface 20 and the bottom surface 22 of the belt 12. Additionally, the bladder 34 is centrally positioned between the first end 16 and the second end 18 of the belt 12. A pump 36 is positioned between the top surface 20 and the bottom surface 22 of the belt 12. The pump 36 has an inlet 38 and an outlet 40, and the outlet 40 is in fluid communication with the bladder 34. The pump 36 is electrically coupled to the control circuit 32. Additionally, the control circuit 32 alternatively actuates the pump 36 between an inflating condition and a deflating condition when the control circuit 32 receives the pump input.

The pump 36 urges air inwardly through the inlet 38 and outwardly through the outlet 40 when the pump 36 is actuated into the inflating condition for inflating the bladder 34. The pump 36 urges air inwardly through the outlet 40 and outwardly through the inlet 38 when the pump 36 is actuated into the deflating condition for deflating the bladder 34. The pump 36 may comprise an electric air pump or the like that can both blow air and suck air. A servo 41 is integrated into the bladder 34 and the servo 41 is electrically coupled to the control circuit 32. The servo 41 is repeatedly turned on and off when the control circuit 32 receives the pump input and the servo 41 is in mechanical communication with the belt 12. In this way the servo 41 communicates an impact into the belt 12 when the control circuit 32 receives the pump input. Thus, the servo 41 simulates a parent patting the infant's 13 back 30 for burping the infant 13. The servo 41 may comprise an electro-mechanical servo or the like.

A heating element 42 is integrated into the belt 12 such that the heating element 42 is in thermal communication with the infant 13 when the belt 12 is worn. The heating element 42 is in thermal communication with the belt 12 such that the heating element 42 heats the belt 12 when the heating element 42 is turned on. In this way the heating element 42 can warm the infant 13. The heating element 42 is positioned between the top surface 20 and the bottom surface 22 of the belt 12. Moreover, the heating element 42 comprises a plurality of coils 44 that are spaced apart from each other and are distributed between the first end 16 and the second end 18 of the belt 12. The heating element 42 is electrically coupled to the control circuit 32 and the heating element 42 is turned on when the control circuit 32 receives the heat input. The heating element 42 may comprise an electric heating element with an operational temperature ranging between approximately 80.0 degrees Fahrenheit and 100.0 degrees Fahrenheit.

A vibration unit 46 is provided and the vibration unit 46 is integrated into the belt 12. In this way the vibration unit 46 is in communication with the infant 13 when the belt 12 is worn. The vibration unit 46 is in mechanical communication with the belt 12 such that the vibration unit 46 vibrates the belt 12 when the vibration unit 46 is turned on. In this way the vibration unit 46 can massage the infant 13. The vibration unit 46 is positioned between the top surface 20 and the bottom surface 22 of the belt 12, and the vibration unit 46 is electrically coupled to the control circuit 32. The vibration unit 46 is turned on when the control circuit 32 receives the vibration input. Additionally, the vibration unit 46 may include an electric motor and an eccentric lobe that is rotatably coupled to the electric motor.

A receiver 48 is provided and the receiver 48 is integrated into the belt 12. The receiver 48 is electrically coupled to the control circuit 32. Additionally, the receiver 48 may comprise a radio frequency receiver or the like. A light emitter 50 is coupled to the top surface 20 of the belt 12 to emit light outwardly therefrom. The light emitter 50 is electrically coupled to the control circuit 32 and the light emitter 50 is turned on to emit a first color of light when the control circuit 32 receives either of the pump input, the heat input or the vibrate input. In this way the light emitter 50 visually alerts the caregiver that the control circuit 32 is turned on. The light emitter 50 may comprise an LED or other similar type of electronic light emitter.

An electronic timer 52 is positioned between the top surface 20 and the bottom surface 22 of the belt 12 and the electronic timer 52 is electrically coupled to the control circuit 32. The electronic timer 52 is actuatable to count down a chosen one of a plurality of pre-determined durations of time. Additionally, the control circuit 32 is turned off when the electronic timer 52 counts down the chosen pre-determined duration of time. The pre-determined durations of time may range between 5.0 minutes and 30.0 minutes.

A remote control 54 is provided that can be manipulated by a caregiver. The remote control 54 is in remote communication with each of the inflation unit 28, the heating element 42 and the vibration unit 46. Moreover, the remote control 54 turns each of the inflation unit 28, the heating element 42 and the vibration unit 46 on and off. The remote control 54 includes a transmitter 56, an inflate button 58, a vibrate button 60, a heat button 62 and a timer button 64. Additionally, the transmitter 56 is in wireless communication with the receiver 48.

The transmitter 56 broadcasts an inflation command to the receiver 48 when the inflate button 58 is depressed and the transmitter 56 broadcasts a heat command to the receiver 48 when the heat button 62 is depressed. The transmitter 56 broadcasts a vibrate command to the receiver 48 when the vibrate button 60 is depressed. Moreover, the timer counts down the chosen pre-determined duration of time when the timer button 64 is depressed a corresponding number of times. The control circuit 32 receives the inflation command when the receiver 48 receives the inflation command and the control circuit 32 receives the heat input when the receiver 48 receives the heat command. The control circuit 32 receives the vibrate input when the receiver 48 receives the vibrate command. The transmitter 56 may comprise a radio frequency transmitter 56 or the like.

A microphone 66 may be provided and the microphone 66 may be coupled to the belt 12 for sensing audible sounds. The microphone 66 may be electrically coupled to the control circuit 32 and the control circuit 32 may be turned off when the microphone 66 senses the sound of the infant 13 burping. Thus, the inflation unit 28 may be turned off when the infant 13 has been burped. The microphone 66 may comprise an electronic microphone or the like and the control circuit 32 may have sound recognition capabilities.

A power supply 68 is integrated into the belt 12 and the power supply 68 is electrically coupled to the control circuit 32. The power supply 68 comprises a rechargeable battery 70 that is positioned between the top surface 20 and the bottom surface 22 of the belt 12. The rechargeable battery 70 is electrically coupled to the control circuit 32. A charge port 72 is recessed into the belt 12 to insertably receive a charge cord. The charge port 72 is electrically coupled to the rechargeable battery 70 for charging the rechargeable battery 70.

In use, the belt 12 is wrapped around the infant's 13 torso 14 when the infant 13 needs to be burped. The caregiver manipulates the remote control 54 to turn on the inflating unit, the vibration unit 46 or the heating element 42. In this way the infant 13 can be automatically burped rather than being manually burped by the caregiver. Additionally, the vibration unit 46 and the heating element 42 can be turned on during burping to enhance comfort for the infant 13 during burping. The vibration unit 46 and the heating element 42 can each be turned on independently of the inflation unit 28 for soothing the infant 13 without burping the infant 13.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An infant burping assembly for automatically burping an infant, said assembly comprising:
a belt being longitudinally elongated wherein said belt is configured to be worn around an infant's torso;
a first mating member being coupled to said belt;
a second mating member being coupled to said belt, said second mating member being releasably matable to said first mating member for forming said belt into a closed loop wherein said belt is configured to be retained around the infant's torso;
an inflation unit being integrated into said belt wherein said inflation unit is configured to be in communication with the infant's back when said belt is worn, said inflation unit being repeatedly inflated and deflated when said inflation unit is turned on wherein said inflation unit is configured to repeatedly engage the infant's back for burping the infant;
a heating element being integrated into said belt wherein said heating element is configured to be in thermal communication with the infant when said belt is worn, said heating element being in thermal communication with said belt such that said heating element heats said belt when said heating element is turned on wherein said heating element is configured to warm the infant;
a vibration unit being integrated into said belt wherein said vibration unit is configured to be in communication with the infant when said belt is worn, said vibration unit being in mechanical communication with said belt such that said vibration unit vibrates said belt when said vibration unit is turned on wherein said vibration unit is configured to massage the infant; and
a remote control being configured to be manipulated by a caregiver, said remote control being in remote communication with each of said inflation unit, said heating element and said vibration unit, said remote control turning each of said inflation unit, said heating element and said vibration unit on and off.

2. The assembly according to claim 1, wherein:
said belt has a first end, a second end, a top surface and a bottom surface wherein said bottom surface is configured to be positioned against the infant when said belt is worn, said belt being elongated between said first end and said second end;
said first mating member being positioned on said top surface, said first mating member being positioned adjacent to said first end; and
said second mating member being positioned on said bottom surface, said second mating member being aligned with said second end.

3. The assembly according to claim 1, wherein said inflation unit comprises a control circuit being integrated into said belt, said control circuit receiving a pump input, said control circuit receiving a heat input, said control circuit receiving a vibrate input.

4. The assembly according to claim 3, wherein said inflation unit comprises a bladder being positioned between said top surface and said bottom surface of said belt, said bladder being centrally positioned between said first end and said second end of said belt.

5. The assembly according to claim 4, wherein said inflation unit comprises a pump being positioned between said top surface and said bottom surface of said belt, said pump having an inlet and an outlet, said outlet being in fluid communication with said bladder, said pump being electrically coupled to said control circuit, said control circuit alternatively actuating said pump between an inflating condition and a deflating condition when said control circuit receives said pump input.

6. The assembly according to claim 5, wherein said pump urges air inwardly through said inlet and outwardly through said outlet when said pump is actuated into said inflating condition for inflating said bladder, said pump urging air inwardly through said outlet and outwardly through said inlet when said pump is actuated into said deflating condition for deflating said bladder.

7. The assembly according to claim 3, wherein said heating element is positioned between a top surface and a bottom surface of said belt, said heating element comprising a plurality of coils being spaced apart from each other and being distributed between a first end and a second end of said belt, said heating element being electrically coupled to said control circuit, said heating element being turned on when said control circuit receives said heat input.

8. The assembly according to claim 3, wherein said vibration unit is positioned between a top surface and a bottom surface of said belt, said vibration unit being electrically coupled to said control circuit, said vibration unit being turned on when said control circuit receives said vibration input.

9. The assembly according to claim 2, further comprising a receiver being integrated into said belt, said receiver being electrically coupled to said control circuit.

10. The assembly according to claim 3, further comprising a light emitter being coupled to a top surface of said belt wherein said light emitter is configured to emit light outwardly therefrom, said light emitter being electrically coupled to said control circuit, said light emitter being turned on when said control circuit receives either of said pump input, said heat input or said vibrate input wherein said light emitter is configured to visually alert the caregiver that said control circuit is turned on.

11. The assembly according to claim 9, wherein said remote control includes a transmitter, an inflate button, a vibrate button, a heat button and a timer button, said transmitter being in wireless communication with said receiver, said transmitter broadcasting an inflation command to said receiver when said inflate button is depressed, said transmitter broadcasting a heat command to said receiver when said heat button is depressed, said transmitter broadcasting a vibrate command to said receiver when said vibrate button is depressed.

12. The assembly according to claim 11, wherein:
said assembly includes an electronic timer being positioned between a top surface and a bottom surface of said belt, said electronic timer being electrically coupled to said control circuit, said electronic timer being actuatable to count down a chosen one of a plurality of pre-determined durations of time, said control circuit being turned off when said electronic timer counts down said chosen pre-determined duration of time; and
said timer counting down said chosen pre-determined duration of time when said timer button is depressed a corresponding number of times.

13. The assembly according to claim 11, wherein said control circuit receives said inflation command when said receiver receives said inflation command, said control circuit receiving said heat input when said receiver receives said heat command, said control circuit receiving said vibrate input when said receiver receives said vibrate command.

14. The assembly according to claim 3, further comprising a power supply being integrated into said belt, said power supply being electrically coupled to said control circuit, said power supply comprising:
a rechargeable battery being positioned between a top surface and a bottom surface of said belt, said rechargeable battery being electrically coupled to said control circuit; and
a charge port being recessed into said belt wherein said charge port is configured to insertably receive a charge cord, said charge port being electrically coupled to said rechargeable battery for charging said rechargeable battery.

15. An infant burping assembly for automatically burping an infant, said assembly comprising:
a belt being longitudinally elongated wherein said belt is configured to be worn around an infant's torso, said belt having a first end, a second end, a top surface and a bottom surface wherein said bottom surface is configured to be positioned against the infant when said belt is worn, said belt being elongated between said first end and said second end;
a first mating member being coupled to said belt, said first mating member being positioned on said top surface, said first mating member being positioned adjacent to said first end;
a second mating member being coupled to said belt, said second mating member being releasably matable to said first mating member for forming said belt into a closed loop wherein said belt is configured to be retained around the infant's torso, said second mating member being positioned on said bottom surface, said second mating member being aligned with said second end;
an inflation unit being integrated into said belt wherein said inflation unit is configured to be in communication with the infant's back when said belt is worn, said inflation unit being repeatedly inflated and deflated when said inflation unit is turned on wherein said inflation unit is configured to repeatedly engage the infant's back for burping the infant, said inflation unit comprising:
a control circuit being integrated into said belt, said control circuit receiving a pump input, said control circuit receiving a heat input, said control circuit receiving a vibrate input;
a bladder being positioned between said top surface and said bottom surface of said belt, said bladder being centrally positioned between said first end and said second end of said belt; and
a pump being positioned between said top surface and said bottom surface of said belt, said pump having an inlet and an outlet, said outlet being in fluid communication with said bladder, said pump being electrically coupled to said control circuit, said control circuit alternatively actuating said pump between an inflating condition and a deflating condition when said control circuit receives said pump input, said pump urging air inwardly through said inlet and outwardly through said outlet when said pump is actuated into said inflating condition for inflating said bladder, said pump urging air inwardly through said outlet and outwardly through said inlet when said pump is actuated into said deflating condition for deflating said bladder;
a servo being integrated into said bladder, said servo being electrically coupled to said control circuit, said servo being repeatedly turned on and off when said control circuit receives said pump input, said servo being in mechanical communication with said belt such that said servo communicates an impact into said belt when said control circuit receives said pump input wherein said servo is configured to simulate a parent patting the infant's back for burping the infant;
a heating element being integrated into said belt wherein said heating element is configured to be in thermal communication with the infant when said belt is worn, said heating element being in thermal communication with said belt such that said heating element heats said belt when said heating element is turned on wherein said heating element is configured to warm the infant, said heating element being positioned between said top surface and said bottom surface of said belt, said heating element comprising a plurality of coils being spaced apart from each other and being distributed between said first end and said second end of said belt, said heating element being electrically coupled to said control circuit, said heating element being turned on when said control circuit receives said heat input;
a vibration unit being integrated into said belt wherein said vibration unit is configured to be in communication with the infant when said belt is worn, said vibration unit being in mechanical communication with said belt such that said vibration unit vibrates said belt when said vibration unit is turned on wherein said vibration unit is configured to massage the infant, said vibration unit being positioned between said top surface and said bottom surface of said belt, said vibration unit being electrically coupled to said control circuit, said vibration unit being turned on when said control circuit receives said vibration input;
a receiver being integrated into said belt, said receiver being electrically coupled to said control circuit;
a light emitter being coupled to said top surface of said belt wherein said light emitter is configured to emit light outwardly therefrom, said light emitter being electrically coupled to said control circuit, said light emitter being turned on when said control circuit receives either of said pump input, said heat input or said vibrate input wherein said light emitter is configured to visually alert the caregiver that said control circuit is turned on;
an electronic timer being positioned between said top surface and said bottom surface of said belt, said electronic timer being electrically coupled to said control circuit, said electronic timer being actuatable to count down a chosen one of a plurality of pre-determined durations of time, said control circuit being turned off when said electronic timer counts down said chosen pre-determined duration of time;
a remote control being configured to be manipulated by a caregiver, said remote control being in remote communication with each of said inflation unit, said heating element and said vibration unit, said remote control turning each of said inflation unit, said heating element and said vibration unit on and off, said remote control including a transmitter, an inflate button, a vibrate button, a heat button and a timer button, said transmitter being in wireless communication with said receiver, said transmitter broadcasting an inflation command to said receiver when said inflate button is depressed, said transmitter broadcasting a heat command to said receiver when said heat button is depressed, said transmitter broadcasting a vibrate command to said receiver when said vibrate button is depressed, said timer counting down said chosen pre-determined duration of time when said timer button is depressed a corresponding number of times, said control circuit receiving said inflation command when said receiver receives said inflation command, said control circuit receiving said heat input when said receiver receives said heat command, said control circuit receiving said vibrate input when said receiver receives said vibrate command; and
a power supply being integrated into said belt, said power supply being electrically coupled to said control circuit, said power supply comprising:
a rechargeable battery being positioned between said top surface and said bottom surface of said belt, said rechargeable battery being electrically coupled to said control circuit; and
a charge port being recessed into said belt wherein said charge port is configured to insertably receive a charge cord, said charge port being electrically coupled to said rechargeable battery for charging said rechargeable battery.
